(19) United States
(12) Patent Application Publication
(10) Pub. No.: US 2025/0333055 A1
(43) Pub. Date: Oct. 30, 2025

(54) Method for assisting the movement of a connected vehicle

(71) Applicant: ORANGE, ISSY LES MOULINEAUX (FR)

(72) Inventors: Ghislain Moncomble, Chatillon (FR); Mathieu Lefebvre, Chatillon (FR)

(21) Appl. No.: 18/869,541

(22) PCT Filed: May 30, 2023
(86) PCT No.: PCT/EP2023/064455

§ 371 Date: Nov. 26, 2024

(30) Foreign Application Priority Data
Jun. 2, 2022 (FR) FR2205308

(51) Int. Cl. B60W 30/14

(52) U.S. Cl. CPC B60W 30/143; B60W 2556/45

(57) ABSTRACT

A method for assisting the movement of a connected vehicle which is able to travel on a road network and able to communicate via a communication network having a variable network coverage level. The method includes, on the approach to a zone having a network coverage level which is below a given level, a step of pre-emptively transmitting at least one piece of information relating to the driving instructions which are intended for the connected vehicle in the zone concerned.

This Application is a Section 371 National Stage Application of International Application No. PCT/EP2023/064455, filed May 30, 2023, and published as WO 2023/232821 A1 on Dec. 7, 2023, not in English, which claims priority to and the benefit of French Patent Application No. 2205308, filed Jun. 2, 2022, the contents of which are incorporated herein by reference in their entireties.

### TECHNICAL FIELD

The technical field is that of connected motor vehicles.

More specifically, the invention relates to a method for assisting the movement of a connected vehicle which is able to travel on a road network and able to communicate via a communication network having a variable network coverage level.

Connected vehicles are those which have on board a terminal or communication means which make it possible for them to be connected to a mobile telecommunication network. The connection to this network makes it possible for the connected vehicle to have normal telecommunication services for its passengers. The connection may also be used for standardized transmission of data transmitted by recent connected vehicles to supervision means. These data transmitted by the connected vehicles comprise, for example, their position, their speed or pieces of information relating to emergencies (presence of accidents or of dangerous decelerations). The connection may also be used to improve functionalities which are specific to the vehicles, namely, for example, the autonomous or non-autonomous driving of the vehicles, by providing them with a whole set of pieces of information on the environment and possibly driving instructions. Several driving modes are then possible for the connected vehicles. In the simplest mode, the vehicle is driven by a driver on board the vehicle and the network connection makes it possible for them to receive pieces of driver assist information. In a more complex mode, the vehicle is driven autonomously by an artificial intelligence on board the vehicle, assisted by pieces of information about the environment which originate from sensors of the vehicle or are transmitted by virtue of the communication network. In another mode, the vehicle is remote-controlled, by a human or artificial operator. Several variants are possible according to the various levels of autonomy of the vehicle and therefore according to the driving tasks taken charge of by the vehicle and those taken charge of by remote control. The driving instructions are then transmitted by the communication network, as well as pieces of information about the environment, which make it possible for the external operator to drive the vehicle. The communication network may also be used to send messages between connected vehicles in order to facilitate autonomous or non-autonomous driving, in addition to the capacities for direct communication between vehicles at a short distance.

### PRIOR ART

With the increase in power of the 5G mobile network and the rise of mobile communication bitrates, it is possible to offer novel services to connected vehicles. In addition to the normal communication services which may be offered to passengers of vehicles, the connection of vehicles makes it possible to facilitate driver assist services for vehicles. These services may just provide assistance to human driving, or indeed provide assistance to the autonomous driving of the vehicle by an on-board system. The high-speed mobile communication network will make it possible for the connected vehicle to have pieces of information, for example, on the map and on the navigation planned if an itinerary has been fixed, or on the movement around the connected vehicle. The communication network also makes it possible for a connected vehicle to address messages to other connected vehicles, once again in order to facilitate driver assist or autonomous driving systems by making it possible for vehicles to warn one another as they approach one another. The international patent application published under the number WO 2019/002734 A1, from the same applicant as the present patent application, presents a method for flagging a driving suggestion to connected vehicles.

It may be noted that it is envisaged that the driver assist services for vehicles may extend to a service for remote-controlling vehicles. In this case, the mobile communication network would transmit driving instructions to the vehicle, which are defined either by an automatic control system or by a remote human driver. The vehicle must then transmit, to the automatic or human teleoperator, via the mobile communication network, the data which make it possible for them to carry out this remote control, such as pieces of information on the situation of the lanes around the vehicle and possible video, radar or lidar feedback.

The importance of having a high-performance, high-speed mobile communication network is clearly understood in this case. Indeed, the safety of the driver assist services may now depend on the performance of the mobile communication network used by connected vehicles.

A first point is to ensure that the latency of the mobile communication network is suitable for the driver assist services envisaged to be able to be executed safely. The latency is the incompressible minimum time measured between the start of sending a message and the start of receiving the same message. This delay is due to the operations of the network for transmitting the message. If the latency of the network is too high, the information messages which are useful to the driver assist services will not arrive in a time which is useful to the vehicles concerned.

Another drawback of the current situation, besides the latency of mobile communication networks, is the presence, on the road network, of zones referred to as white, namely zones where the network coverage is low or zero. Even if the coverage of high-speed mobile networks progresses regularly, it may not be sufficient for remote-control applications on the entirety of the road network. Rather than white zones, zones with low network coverage, in which connected vehicles will have few network resources at their disposal, will be present.

In general, connected vehicles need network resources. These resources are, first of all, the accessibility of communication services, such as the possibility of being authenticated, of transmitting and receiving messages, of having a data link or others. Once the accessibility of the services has been established, the network resources will be described by measurable quantities, such as, for example, the latency already discussed, but also the bitrate of the communications, which is measured in MB/s (megabytes per second). The presence of several connected vehicles may decrease the network resources at the disposal of vehicles and, for example, decrease the bitrate which is available for each vehicle.

The situation created by the presence of zones with low network coverage presents a clear safety risk. Indeed, the absence of network connectivity may prevent the services for remote-controlling a connected vehicle, or degrade the autonomous driving or driver assist services by preventing pieces of information from being transmitted and received by connected vehicles.

The invention aims to improve the situation.

### SUMMARY

According to a first functional aspect, the invention relates to a method for assisting the movement of a connected vehicle which is able to travel on a road network and able to communicate via a communication network having a variable network coverage level, said method being characterized in that it comprises, on the approach to a zone having a network coverage level which is below a given level, a step of pre-emptively transmitting at least one piece of information relating to the driving instructions which are intended for the connected vehicle in said zone concerned.

By virtue of the invention, the connected vehicle will not suddenly be in a zone with low network coverage. Determining the zones with low network coverage will make it possible to detect the vehicles for which the loss of network connectivity may occur and will make it possible to take adaptive measures as a function of the at least one piece of information received with regard to the driving instructions for the connected vehicle in order to ensure good movement even in a zone with low network coverage.

The piece of information relating to the driving instructions may take many forms. It may be an instruction as such, which will make the vehicle change driving mode. It may be a change of parameter of a driving mode which remains unchanged, for example the change of target speed in a driving mode which remains unchanged. It may, finally, be providing one or more parameters relating to the driving mode, for example providing pieces of information on one or more meetings to come. Finally, it may merely be the piece of information that the network communications will be degraded to a certain extent on the next entry into the zone with low network coverage.

It should be noted that the order in which the steps of the method are executed may be able to vary according to the conditions in which the method is implemented. The network coverage level of a zone may be determined once and for all, even if this is not the preferred embodiment, and the other steps may be executed without renewing this determination.

According to another first particular mode of implementation of the invention, at least one piece of information relating to the driving instructions which are intended for said vehicle is transmitted before said vehicle enters the zone with low network coverage.

By virtue of this first mode, the method ensures that the necessary instructions are indeed transmitted to the connected vehicle before the latter enters the zone with low network coverage.

According to a second particular mode of implementation of the invention, which may be implemented as an alternative or in addition to the previous mode, the network coverage level on the approach is determined using pieces of information on coverage level measurements carried out in the past. Preferably, the pieces of measurement information used are pieces of information on measurements carried out recently, for example less than quarter of an hour or half an hour ago according to the traffic in the zones which are the objects of these measurements; the duration chosen will depend on the use case. They are generally measurements carried out by vehicles which have just entered the zones in question and may detect network incidents which have just occurred.

It should be specified here that the measurements of the coverage level may be carried out by a communication means which may be an autonomous mobile terminal which is present in a vehicle or even carried by a pedestrian, but also any other means for communicating with the mobile network on board a vehicle.

By virtue of this second mode, the network coverage level is determined based on recent measurements of the network coverage. Communication means (mobile telephones or means on board connected vehicles) may, at any moment, pass on pieces of information on the network coverage which they observe. These data make it possible for the network coverage level to be determined based on up-to-date data and to provide a more accurate result.

According to a third particular mode of implementation of the invention, which may be implemented as an alternative or in addition to the previous modes, said given value is obtained as a function of a need for network capacity of the connected vehicle.

In this mode, a network zone will be considered to have low coverage for a subset of communication means or terminals which are liable to enter the zone. In particular, the zones with low network coverage are determined as a function of the needs in terms of the network capacity which is necessary to each vehicle, which needs are expressed in a given value. Thus, a zone with low network capacity will be defined for a vehicle having a greater need in terms of network capacities (for example, for a remote-controlled vehicle, for which passing on video filmed by one or more cameras of said vehicle is necessary for remote control), while this zone will not be determined as having low network coverage for other vehicles needing only low-capacity network means (for example, periodically passing on their position, trajectory, speed or other parameters of the same type which represent a low volume of data).

The advantage of this mode is to refine the determination of the zones with low network coverage by limiting it according to the actual needs of the connected vehicles. In this way, the method will not judge as having low network coverage zones which make it possible for connected vehicles to move according to their driving mode if the latter needs only a few data transmissions.

According to a fourth particular mode of implementation of the invention, which may be implemented as an alternative or in addition to the previous modes, the at least one piece of information relating to the driving instructions comprises a request to change travel speed.

By virtue of this particular mode of implementation of the invention, it will be possible to regulate the arrival of connected vehicles in a zone with low network coverage. In this way, by staggering the passing of connected vehicles, it may be possible to conserve a network capacity which is sufficient for each vehicle, at the risk of delaying the entry of a given vehicle into the zone. Furthermore, the change in the travel speed may make it possible for the vehicle concerned to decrease the potential meetings of the connected vehicle with other vehicles or obstacles. This type of instructions would also have been transmitted to the connected vehicle in the absence of a zone with low network coverage. The method then has the advantage of transmitting the piece of information before the connected vehicle enters the zone with low network coverage.

According to a fifth particular mode of implementation of the invention, which may be implemented in addition to the previous modes, the at least one piece of information relating to the driving instructions comprises providing a new itinerary.

By virtue of this particular mode of implementation of the invention, the connected vehicles will avoid zones with low network coverage by following another itinerary along which their needs for network capacity for maintaining a particular driving mode will indeed be met.

According to a sixth particular mode of implementation of the invention, which may be implemented in addition to the previous modes, the at least one piece of information relating to the driving instructions comprises an instruction to the connected vehicle relating to the driving mode for decreasing its needs for network capacity.

By virtue of this particular mode of implementation of the invention, the connected vehicles will follow a driving mode which is suitable for the network capacity of the zone with low network capacity when they pass through said zone. Indeed, according to the communication capacities available, the connected vehicle will receive one or more instructions to change driving modes which will decrease their needs for network capacity. Autonomous driving functions may thus be activated or deactivated, or parameters may be changed. For example, an autonomous driving mode may be deactivated on the approach to a crossroads situated in a zone with low network coverage, since this mode makes it necessary to transmit a list of vehicles which are liable to be met at the crossroads, and transmitting this list uses network capacity.

According to a first hardware aspect, the invention relates to a management entity managing a method for assisting the movement of a connected vehicle which is able to travel on a road network and able to communicate via a communication network having a variable network coverage level, said management entity being characterized in that it comprises the following modules:
a detection module which is able to detect when a connected vehicle approaches a zone having a network coverage level which is below a given level;
a transmission module which is able to pre-emptively transmit at least one piece of information relating to the driving instructions which are intended for said connected vehicle in said zone concerned.

According to another hardware aspect, the invention relates to a computer program which is able to be implemented by a management entity, the program comprising code instructions which, when it is executed by a processor, carry out the steps of the management method defined above.

According to another hardware aspect, the invention relates to a data medium on which is recorded a computer program comprising a sequence of instructions for implementing the management method defined above.

The data media may be any entity or device which is capable of storing the programs. For example, the media may comprise a storage means, such as a ROM, for example a CD-ROM or a microelectronic circuit ROM, or else a magnetic recording means, such as a hard disk. On the other hand, the media may be transmissible media such as an electrical or optical signal, which may be routed via an electrical or optical cable, by radio or by other means. The programs according to the invention may in particular be downloaded from the Internet. Alternatively, the data medium may be an integrated circuit into which the program is incorporated, the circuit being suitable for executing or for being used in the execution of the method in question.

### BRIEF DESCRIPTION OF THE DRAWINGS

The invention will be better understood on reading the following description, which is given by way of example and with reference to the appended drawings, in which:

FIG. 1 depicts a management entity according to the invention communicating with a connected vehicle.

FIG. 2 depicts a possible driver assist modality for a connected vehicle.

### DETAILED DESCRIPTION OF ONE OR MORE EXAMPLES OF EMBODIMENTS OF THE INVENTION

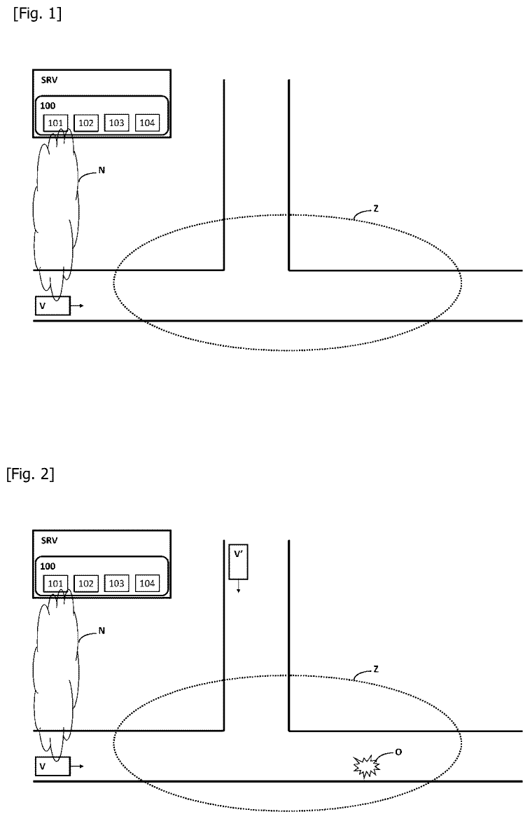

FIG. 1 depicts a management entity 100. The latter communicates with a connected vehicle V via a communication network N. In FIG. 1, the vehicle V is on the approach to a zone Z, in other words on the point of entering a zone Z with low network coverage.

A low network coverage level is a level which is not sufficient for the vehicle V to communicate via this network and be able to transmit or receive the amount of data which is necessary for moving according to a given driving mode. This is determined with respect to a given level which expresses the needs of the one or more connected vehicles according to their driving mode.

In the method according to the invention, zones Z having a network coverage level which is below a given level will be determined. Such zones will also be referred to as zones with low network coverage.

In the example of an embodiment described in the figures, the management entity 100 comprises four modules, namely:
an optional module 101 for determining a zone Z of the road network with low network coverage;
a detection module 102 which is able to detect when a connected vehicle V approaches a zone Z having a network coverage level which is below a given level;
an optional module 103 for evaluating the capacity of the network N to transmit data which are necessary to the movement of the connected vehicle V when the latter moves in said zone Z with low network coverage;
a transmission module 104 which is able to pre-emptively transmit at least one piece of information relating to the driving instructions which are intended for said vehicle V in said zone Z concerned.

The management entity 100 may be included, for example, in a server SRV, or a set of servers, implementing the method according to the invention. It has the hardware architecture of a conventional computer and notably comprises a processor, a random-access memory (RAM), a read-only memory (ROM) such as a Flash memory (which are not depicted in the figure) as well as input/output devices which will in particular make it possible for it to communicate with connected vehicles V via a mobile communication network N.

In this example, the first step (a) of the method consists, for the management entity 100, in determining a zone Z of the road network with low network coverage. Such a zone is a zone where a network resource is not widely accessible to the connected vehicles V. It is, for example, a measurement of a capacity of the network N which makes it possible to decide that a resource is not widely accessible when the measurement is situated below a certain threshold. An example of a measurement is that of the bitrate, which is expressed in MB/s.

It is the determination module 101 which will carry out this step. In the zone Z, the capacities of the mobile communication network N are reduced, which may cause malfunctions of the driving mode used by the connected vehicle V.

The determination step (a) will be based on several elements of information for determining a zone Z with low network coverage. They may be maps of the locations of the antennas of the mobile communication network, on the basis of which a simulation of the network coverage may be carried out. These simulations may make it possible to determine (a) zones Z of the road network which have low coverage by the mobile communication network. These simulations may be complemented or improved by measurement campaigns in which measurements of the coverage of the mobile network are made at precise points of the road network. In one embodiment, one way of determining (a) a zone Z with low network coverage consists in using coverage measurements made by mobile communication means of users connected to the network. These communication means may be mere mobile terminals of users, whether they are in a vehicle or not, but also communication systems on board the connected vehicles moving on the road network. These communication means may pass on pieces of geolocated information on the quality of the network coverage as they travel if the users have given their consent for this passing on of pieces of information. This passing on of pieces of information then makes it possible to enrich, in real time, network coverage maps and to detect, in advance, possible incidents which degrade the network coverage. The passing on of information originating from connected vehicles will be favored since it gives, by its nature, a piece of information with regard to the network capacity on the road network and not in its vicinity. Preferably, the measurements used will be recent measurements in order to be sure that they are still up to date.

The determination (a) of a zone Z with low network coverage takes into account the communication needs of the connected vehicles V which are necessary to each driving mode which they are liable to implement on the portion of the road network which they will be made to pass through, independently of the network capacity which is actually available. In this example, the determination (a) also takes into account the number of connected vehicles V which are called upon to move in the zone Z with low network coverage. As a function of these two constraints, it may be determined that a location in the road network may have coverage by the mobile communication network with a certain quality level which will be sufficient for connected vehicles V implementing certain communication services, but will not be sufficient for other services. In particular, remote-controlled driving services need large amounts of network resources. Indeed, this type of remote driving makes it necessary to transmit data needing a substantial passband, such as, for example and at a minimum, a view of the road facing the vehicle transmitted by at least one panoramic imaging device, this transmission having to be done in real time in order to ensure the vehicle V is driven remotely. These transmissions therefore require both a very large passband and a very low latency. A zone in which a certain network coverage is present may therefore be determined (a) as being a zone Z with low network coverage if the management entity predicts that one or more connected vehicles V will pass through it, as a function of the network capacities which are necessary for implementing the driving modes which these vehicles may potentially use on each of the portions of the zone to be passed through, and as a function of the amount of vehicles which are called upon to pass through the zone Z.

This prediction, by the management entity 100, that connected vehicles V will pass through a zone Z will be based on several data. This may be direct passing on, from the connected vehicles V to the management entity 100, of the itineraries which they plan to follow, as well as network communication needs which the connected vehicles V predict for the various portions of their journey. The management entity 100 may therefore have the piece of information that a vehicle V, which has communicated its itinerary to it, should be in the zone Z at such or such a moment and that it predicts such or such a need for network capacity on each portion of said zone.

In addition, the management entity 100 may have access to other pieces of movement information. This may be, for example, movement histories and histories of the consumption of the network resources which make it possible to detect zones Z with low network coverage recurrently. The connected vehicles V may pass on to the management entity 100 pieces of information with regard to the movement which they observe in real time in order to refine the predictions using the movement histories. Other pieces of real-time movement information, originating, for example, from cameras arranged on the road network, may also be used. These movement predictions may be used to predict the consumption of network resources by assuming that a certain proportion of the vehicles in movement are connected vehicles, even if they are not in communication with the management entity 100.

In this example, the second step (b) of the method consists, for the management entity 100, in detecting that a connected vehicle V will be called upon to move in the zone Z with low network coverage determined (a) in the previous step. This step is implemented by the detection module 102.

Once the zones Z with low network coverage have been determined (a), in this example, the management entity 100 will use the itineraries which are provided to it by the connected vehicles V to detect whether the vehicle V must pass through a zone Z with low network coverage.

It has been seen that the determination step (a) was carried out using predictions of itineraries provided by the connected vehicles V to the management entity 100. These same predictions are used to carry out the detection step (b). The sequencing of the determination step (a) and detection step (b) is therefore not obligatory; the detection step (b) will often take place during the determination step (a).

In the case where the connected vehicles V do not pass on their predicted itinerary, the management entity 100 may rely on the regular passing on of the geolocation of the connected vehicle V as well as on its current speed in order to anticipate its most probable next movements and therefore the potential passing-through of a zone Z with low network coverage.

In this example, the third step (c) of the method will consist, for the management entity 100, in evaluating the capacity of the network N to transmit data which are necessary to the movement of the connected vehicle V when the latter moves in said zone Z with low network coverage. This step is implemented by the evaluation module 103.

A zone Z with low network coverage does not, in general, have a zero level of coverage by the communication network N. It is not a white zone without any communication capacity. However, the zone Z has low network coverage which will not make it possible for the connected vehicle V to use the driving modes which consume the most network resources. It has been seen that a driving mode which consumes a lot is remote control, which makes it necessary to transmit, in real time, data collected by sensors of the connected vehicle V such as at least one on-board camera. The evaluation step (c) will therefore consist in evaluating whether the driving mode of the connected vehicle V is compatible with the network resources which should be available when the vehicle V enters the zone Z with low network coverage.

The evaluation step (c) will also take into account the result of the determination (a) of the zone Z with low network coverage and position and trajectory parameters, such as the speed and the direction of the connected vehicle V.

In this example, the fourth step (d) of the method will consist, for the management entity 100, in transmitting at least one piece of information relating to the driving instructions which are intended for said vehicle V, the instant of transmission being a function of the result of the evaluation of the capacity of the network N. The step (d) of transmitting at least one instruction is implemented by the transmission module 104 of the management entity 100. The at least one piece of information transmitted during step (d) may make it possible to ensure that the needs for network resources required by the driving mode of the connected vehicle V do not exceed the capacities of the network N in the zone Z with low network coverage.

In one variant, at least one piece of information transmitted (d) will make it possible for the vehicle V to adapt its driving at the right moment with respect to other vehicles the flagging of which is provided in said pieces of information, in relation to a near future instant and a portion of lane in the zone Z, said instant and said portion of lane being dependent on the driving parameters of the vehicle V, and on the assumptions about the travel speed and about the trajectory of the other vehicles evaluated in said zone Z.

In one embodiment, the instant at which at least one instruction relating to the driving mode of the vehicle is transmitted (d) takes place before the vehicle V enters the zone Z with low network coverage. In this way, it is certain that the instructions are indeed transmitted before availability of the network resources decreases after the vehicle V enters the zone Z.

In one embodiment, the at least one piece of information transmitted to the connected vehicle V called upon to move in a zone Z with low network coverage consists of a request to change the travel speed of the connected vehicle V. In this way, the management entity 100 will seek to regulate the arrival of connected vehicles, which consume a lot of network resources, in the zone Z with low network coverage. This instruction to change speed may, in extreme cases, extend to an instruction to stop the connected vehicle V. In this way, the management entity 100 may guarantee that the connected vehicle V will not enter a zone Z with low network coverage. The instruction to change speed may also be combined with an implementation delay. In this case, the instruction is not implemented as soon as it is transmitted, but when a delay provided elapses. This embodiment makes it possible to apply the instruction to change speed at the most appropriate moment, even if the latter occurs when the connected vehicle V is situated in a zone Z with low network coverage.

In another embodiment, the at least one piece of information relating to the driving instructions which is transmitted (d) to the connected vehicle V called upon to move in a zone Z with low network coverage consists in providing a new itinerary which makes it possible to avoid the zone Z with low network coverage. In this way, once again, the method implemented by the management entity 100 will guarantee that the connected vehicle V will not enter a zone Z with low network coverage.

In another embodiment, the at least one piece of information relating to the driving instructions which is transmitted (d) to the connected vehicle V called upon to move in a zone Z with low network coverage consists of an instruction to the connected vehicle V to change driving mode in order to decrease its needs for network capacity.

One driving mode which consumes a lot of network resources, as has already been seen, is the remote-control mode. This mode makes it necessary to transmit, in real time, data collected by at least one front camera of the connected vehicle V and by other sensors. The method implemented by the management entity 100 will therefore, for example, give an instruction to the connected vehicle V to abandon this driving mode in order to move, for example, into an autonomous driving mode which will consume fewer network resources. The method may also give an instruction to the connected vehicle V to move into a mode of being driven by its driver in order to avoid any driving failure after moving into the zone Z with low network coverage.

The piece of information relating to the instructions may also consist of an order not to change driving mode when the connected vehicle V is in the zone Z with low network coverage. In this way, if the current driving mode of the connected vehicle V is sufficiently economical in terms of network resources, it will not be degraded when the vehicle V moves into the zone Z with low network coverage; however, the driving mode may not be changed to a mode which consumes more resources.

The piece of information relating to the instructions which is transmitted (d) may also relate to the driving mode without changing the latter. It may consist of an instruction to decrease the quality of the data which are transmitted, or in sampling the data which are transmitted. In this way, the network resources consumed by the driving mode will decrease without changing the driving mode itself. The quality of the driving mode will, however, be degraded in order to preserve the capacity to move in the zone (Z) with low network coverage.

In general, recall that the piece of information relating to the driving instructions which is transmitted during step (d) may take many forms. It may be an instruction as such, which will make the vehicle change driving mode. It may be a change of parameter of a driving mode which remains unchanged, for example the change of target speed in a driving mode which remains unchanged. It may, finally, be providing one or more parameters relating to the driving mode, for example providing pieces of information on one or more meetings to come. Finally, it may merely be the piece of information that the network communications will be degraded to a certain extent on the next entry into the zone with low network coverage, which piece of information will possibly be transmitted to the driver of the connected vehicle V, or will be used by the connected vehicle V to adapt its autonomous driving mode to passing in the future through a zone Z with low network coverage.

FIG. 2 depicts one example of a possible use of the management entity 100 to improve the driving of the connected vehicles V. The management entity 100 will determine a list of obstacles which the vehicle V is liable to encounter while it passes through the zone Z having a network coverage level which is below a given level, in other words having low network coverage. These obstacles may be a fixed obstacle O which is present in the zone Z, or indeed another vehicle V′, the management entity 100 of which may determine the itinerary and that the vehicle V should meet the vehicle V′ while it passes through the zone Z. Note that the vehicles V′ may be connected vehicles, or indeed unconnected vehicles the position and the trajectory parameters of which would have been determined according to the prior art, for example by other connected vehicles V. The management entity 100 may obtain pieces of information with regard to the presence of an obstacle O in the zone Z by virtue of passing on of information done by road maintenance services, or indeed by cameras filming the road network, or indeed by connected vehicles V which transmit pieces of information about the obstacles which they encounter, either inside the zone Z if they have the network capacity which is necessary for transmitting said pieces of information, or as soon as they have the capacity to do so. In which case, the pieces of information which are transmitted relating to these obstacles encountered previously are transmitted with reference to both the instant of their detection and the geolocation at the instant of said detection. Additional pieces of information such as the evaluated speed and trajectory of the obstacle encountered may also be transmitted at this time. As far as the vehicle V′ is concerned, it has been seen that the management entity 100 uses, during the determination phase (a), predictions of the movement of the connected or unconnected vehicles. These pieces of information may be used to predict that the connected vehicle V should meet a vehicle V′, whether the latter is connected or not, when it passes through the zone Z with low network coverage.

The management entity 100 may therefore transmit a list of predicted obstacles to the connected vehicle V, each predicted obstacle being able to be coupled with an additional series of pieces of information such as the predicted trajectory of the obstacle (if it is traveling), its predicted speed and position at such an instant, or any other relevant piece of information, said additional pieces of information being able to be associated with a probability of occurrence. Pieces of information about a predicted obstacle O or a vehicle V′ which is liable to be met by the connected vehicle V may be transmitted in the form of a series of successive GPS geolocation points, a piece of information giving the probability of the presence of the obstacle O or of the vehicle V′ at the geolocation point as a function of the instants to come in a near future being associated with said geolocation points. This piece of information may be limited by transmitting only the GPS geolocation point and the instant to come for which the meeting of the connected vehicle V with a vehicle V′ or an obstacle O is the most probable.

This list of predicted obstacles may be transmitted before the vehicle V arrives in the zone Z with low network coverage, in order to ensure that transmission will not be prevented by the drop in network resources which are offered by the network N in the zone Z with low coverage.

The vehicle V may then, on leaving the zone Z with low network coverage, send pieces of information to the management entity 100, if the network capacities make it possible. These pieces of information will make it possible to confirm or deny the presence of the fixed obstacles O in the zone Z with low network coverage, and also whether the connected vehicle V has indeed met the vehicle V′ or not. Effectively, this vehicle V′ may have changed direction or indeed have stopped after having been detected as heading toward the zone Z. The connected vehicle V will therefore have to confirm or deny that it met the vehicle V′ in order to improve the predictions of the management entity 100. This sending of pieces of confirming or denying information may be done on leaving the zone Z with low network coverage in order to benefit from the return of good capacity in terms of network resources on the part of the network N.

Lastly, it should be flagged here that, in the present text, the term “module” may correspond equally to a software component or to a hardware component or to a set of software and hardware components, a software component itself corresponding to one or more computer programs or subroutines or, more generally, to any element of a program which is able to implement a function or a set of functions such as described for the modules concerned. In the same way, a hardware component corresponds to any element of a hardware assembly which is able to implement a function or a set of functions for the module concerned (integrated circuit, chip card, memory card etc.).

Although the present disclosure has been described with reference to one or more examples, workers skilled in the art will recognize that changes may be made in form and detail without departing from the scope of the disclosure and/or the appended claims.

1. A management method for assisting movement of a connected vehicle which is able to travel on a road network and able to communicate via a communication network having a variable network coverage level, said method being implemented by a management device and comprising:
on an approach to a zone having a network coverage level which is below a given level, pre-emptively transmitting at least one piece of information relating to driving instructions which are intended for the connected vehicle in said zone.

2. The management method according to claim 1, comprising determining the network coverage level on the approach by using pieces of information on network coverage measurements carried out in the past.

3. The management method according to claim 1, wherein said given level is obtained as a function of a need for network capacity of the connected vehicle.

4. The management method according to claim 1, wherein the at least one piece of information relating to the driving instructions comprises a request to change travel speed.

5. The management method according to claim 1, wherein the at least one piece of information relating to the driving instructions comprises providing a new itinerary.

6. The management method according to claim 1, wherein the at least one piece of information relating to the driving instructions comprises an instruction to the connected vehicle relating to a driving mode for decreasing needs for network capacity.

7. A management device for managing a method for assisting the movement of a connected vehicle which is able to travel on a road network and able to communicate via a communication network having a variable network coverage level, said management comprising:
at least one processor; and
at least one non-transitory computer readable medium comprising instructions stored thereon which when executed by the at least one processor configure the management device to:
detect when the connected vehicle approaches a zone having a network coverage level which is below a given level; and
pre-emptively transmit at least one piece of information relating to driving instructions which are intended for said connected vehicle in said zone.

8. (canceled)

9. A non-transitory computer readable data medium on which is recorded a computer program comprising a sequence of instructions for implementing a management method when the sequence of instructions is loaded into and executed by a processor, the management method comprising:
assisting movement of a connected vehicle which is able to travel on a road network and able to communicate via a communication network having a variable network coverage level, the assisting comprising:
on an approach to a zone having a network coverage level which is below a given level, pre-emptively transmitting at least one piece of information relating to driving instructions which are intended for the connected vehicle in said zone.
